(19) United States
(12) Patent Application Publication
(10) Pub. No.: US 2006/0087744 A1
(43) Pub. Date: Apr. 27, 2006

(54) Optical pickup apparatus including spherical aberration correcting optical system

(75) Inventor: Shinnosuke Torii, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/246,192

(22) Filed: Oct. 11, 2005

(30) Foreign Application Priority Data
Oct. 25, 2004 (JP) 2004-309678

(51) Int. Cl. G02B 27/30

(52) U.S. Cl. 359/641

(57) ABSTRACT

An optical pickup apparatus includes a lens unit which is composed of a first lens group having at least one lens and a second lens group having at least one lens. The first lens group and the second lens group are supported by support members which are engaged with each other. The first lens group and the second lens group are slid in an optical axis direction to change a relative positional relationship between the lens groups, thereby correcting spherical aberration caused in a recording surface of an optical recording medium.

### BACKGROUND OF THE INVENTION

1. Field of the Invention

The present invention relates to an optical system of an optical pickup apparatus, and more particularly to a spherical aberration correcting optical system.

2. Related Background Art

In recent years, in order to increase a recording density of an optical disk apparatus, techniques for shortening a wavelength of a light source and techniques for improving an NA of an objective lens have been actively studied.

According to some techniques, an optical pickup apparatus including a 405 nm band semiconductor laser and an objective lens with an NA of 0.85 is beginning to be commercially available.

When a short-wavelength light source and a high-NA objective lens are to be employed for the optical disk apparatus, there are the following. fundamental problems.

(1) It is easily affected by a tilt of a disk.

(2) It is easily affected by a thickness error of a transparent substrate.

(3) It is easily affected by a wavelength hop of the light source.

In order to solve the problem (1), a thickness of the transparent substrate is reduced. For example, the thickness of the transparent substrate is set to about 100 μm.

In order to solve the problems (2) and (3), an improved optical system has been designed.

For example, in order to solve the problem (3) with respect to the mode hop of the light source, a chromatic aberration correcting lens for producing chromatic aberration for canceling chromatic aberration caused by the objective lens has been further provided in an optical system.

In order to solve the problem (2) with respect to spherical aberration caused when there is a thickness error of the transparent substrate, for example, the following methods have been studied.

(a) A beam expander is further used. Therefore, a lens interval is changed to produce spherical aberration, thereby canceling spherical aberration caused by the thickness error of the transparent substrate.

(b) A position of a collimator lens is changed in an optical axis direction to produce spherical aberration, thereby canceling spherical aberration caused by the thickness error of the transparent substrate.

Such techniques are disclosed by, for example, Japanese Patent Application Laid-Open No. 2002-236252.

To explain it simply, when the beam expander is to be used, as shown in FIG. 6A, an expander 33 which is composed of a lens 31 having negative power and a lens 32 having positive power is provided on an optical path of a parallel light flux which is located on a light incident side of an objective lens 35. An interval between the lens 31 and the lens 32 is changed according to the thickness error of the transparent substrate, thereby producing spherical aberration.

When the position of a collimator lens 34 is to be changed, an optical system as shown in FIG. 6B is used and the collimator lens 34 is moved along an optical axis according to the thickness error of the transparent substrate, thereby producing spherical aberration.

A mechanism for realizing such an optical system is disclosed by, for example, Japanese Patent Application Laid-Open No. 2003-091847.

The mechanism will be described with reference to FIG. 1 (corresponding to FIG. 7 in this specification) and FIG. 3 (corresponding to FIG. 8 in this specification) in Japanese Patent Application Laid-Open No. 2003-091847. An expander lens 16 is composed of a concave lens 16a and a convex lens 16b which are supported by a lens support member 25a and a lens support member 25b, respectively. In FIG. 7, reference numeral 10 denotes a light-emitting device, 11 denotes a collimator lens, 12 denotes an optical system, 13 denotes a beam splitter, 14 denotes a lens, 15 denotes a detector, 17 denotes a mirror, 18 denotes a wavelength plate, 19 denotes an objective lens, 20 denotes an optical system, 21 denotes a detector, 22 denotes a stepping motor, 23 denotes a lead screw mechanism, 26 denotes an angle, and 28 denotes a photosensor.

A guide shaft 27 is inserted into a driving rack 24 integrally engaged with the lens support member 25, so the concave lens 16a can be slid along an optical axis.

The concave lens 16a, the convex lens 16b, and the expander lens 16 composed of the concave lens 16a and the convex lens 16b in Japanese Patent Application Laid-Open No. 2003-091847 are regarded as “a first lens group”, “a second lens group”, and “a lens unit” in this specification, respectively.

When the concave lens 16a is slid by using the guide shaft 27 as described above, another guide shaft (sub-shaft) is generally provided parallel to the guide shaft 27 in order to prevent the lens support member 25a from rotating about the guide shaft 27 and to maintain coaxiality between the optical axis and the concave lens 16a.

In particular, the above-mentioned structure is used for, for example, a Blu-ray Disc recorder which is currently manufactured as a product.

However, the above-mentioned conventional techniques have the following problems.

In general, allowable variations in coaxiality precision of optical elements including the lens unit and in tilt precision of the optical elements are determined in proportion to an effective light flux diameter.

Therefore, the allowable variations become smaller as a reduction in thickness of the optical pickup apparatus progresses to reduce the effective light flux diameter.

More specifically, an optical axis of a general optical pickup apparatus between a laser and a flip-up mirror is parallel to a disk surface.

Therefore, the effective light flux diameter becomes a parameter for limiting a thickness of the optical pickup apparatus (surface perpendicular to the disk surface) In other words, when a reduction in thickness of the optical pickup apparatus is to be achieved, it is essential to reduce the effective light flux diameter. Therefore, a high-precision lens unit is necessary.

Not only an external diameter but also coaxiality precisions of the movable concave lens 16a and the convex lens 16b and tilt precisions thereof relative to the optical axis are required with high precision for the expander mechanism of the expander lens which is the lens unit.

However, with respect to the coaxialities in the expander mechanism, there are at least nine variations in tolerances such as

(a-1) coaxiality between the concave lens 16a and a concave lens engaging portion of the lens support member 25a,

(a-2) a size tolerance between the concave lens engaging portion of the lens support member 25a and the center of an insertion hole of the guide shaft 27,

(a-3) engaging backlash between the insertion hole of the guide shaft 27 of the lens support member 25a and the guide shaft 27,

(a-4) coaxiality of the guide shaft 27,

(a-5) a size tolerance between the concave lens engaging portion of the lens support member 25a and a sub-shaft insertion portion thereof,

(a-6) engaging backlash between the sub-shaft insertion portion of the lens support member 25a and the sub-shaft,

(a-7) coaxiality of the sub-shaft,

(a-8) coaxiality between the convex lens 16b and a convex lens engaging portion of the lens support member 25b, and

(a-9) a size tolerance of the lens support member 25b (such as a size from the convex lens engaging portion to an optical base attaching portion).

With respect to the tilts, there are five variations in tilts such as

(b-1) a tilt of the concave lens 16a and the lens support member 25a,

(b-2) a tilt caused by engaging between the insertion hole of the guide shaft 27 of the lens support member 25a and the guide shaft 27,

(b-3) a tilt of the guide shaft 27 relative to an optical base (not shown),

(b-4) a tilt of the convex lens 16b and the lens support member 25b, and

(b-5) a tilt of the lens support member 25b relative to the optical base.

Therefore, the optical base of the optical pickup apparatus including the expander mechanism requires ensuring of a clearance including the variations, so there is a problem in that a size of the optical pickup apparatus is increased.

The expander mechanism according to the conventional technique requires ensuring of a parallelism between the guide shaft 27 and the sub-shaft in addition to the above-mentioned variations because the concave lens 16a is slid.

Therefore, an adjusting mechanism for adjusting a tilt of a sliding shaft (guide shaft 27) and correcting an eccentricity of a lens is generally provided in the conventional techniques.

This is because the coaxiality precision and the tilt precision of the expander lens relative to the optical axis cannot be ensured without adjusting the above-mentioned variations.

An adjusting mechanism will be described in detail with reference to FIG. 9.

FIG. 9 is a schematic perspective view showing an adjusting mechanism corresponding to the conventional adjusting mechanism as shown in FIGS. 7 and 8. But, some parts of FIG. 9 are excerpted from FIGS. 7 and 8, additional parts are given to FIG. 9, and the shape of some portions are simplified.

Parts in FIG. 9 indicated by the same reference characters as in FIGS. 7 and 8 have the same functions as those of the parts shown by the same reference characters of FIGS. 7 and 8.

In general, heights of both ends of the guide shaft 27 and a height of an end of a sub-shaft 41 are adjusted by using three screws 40 to adjust a parallelism relative to the optical axis, thereby ensuring the coaxiality of the movable concave lens 16a during sliding relative to the optical axis.

At this time, for example, a support surface 42b for supporting the guide shaft 27 is formed on an optical base 42 (in which only a part thereof required for this description is shown) with high precision and the guide shaft 27 is pressed to the support surface 42b of the optical base 42 to determine a position in a direction, indicated by an arrow A, orthogonal to an adjustment direction.

When higher precision is required in the direction indicated by the arrow A, which is orthogonal to the adjustment direction, it is necessary that the guide shaft 27 be not pressed to the support surface 42b but additional adjustment be required for other portions. Therefore, there is a problem in that the number of parts increases.

The held convex lens 16b is made adjustable in two axis directions (arrows A and B) orthogonal to the optical axis to adjust the coaxiality between the optical axis and the movable concave lens 16a.

For example, the lens support member 25b is moved for adjustment by a tool in the two axis directions orthogonal to the optical axis while the lens support member 25b is urged to a held lens side end surface 42a of the optical base 42 by an urging member 43.

This is because the movable concave lens and the held convex lens are separately disposed as in the conventional techniques, thereby making it necessary to perform the adjustment so as to align the movable concave lens and the held convex lens with the optical axis of a light-emitting source.

In particular, an optical element composed of such a lens unit generally has a problem that not only the tilt precision and the coaxiality precision relative to an ideal optical axis but also the tilt precision between two lens groups and the coaxiality precision therebetween are very hard to maintain.

### SUMMARY OF THE INVENTION

An object of the present invention is to provide a high-precision optical pickup apparatus without increasing a size thereof.

The optical pickup apparatus of the present invention is an optical pickup apparatus for condensing light emitted from a light source to a recording surface of an optical recording medium by an objective lens to perform one of information recording and information reproduction, including:

a lens unit for spherical aberration correction, including a first lens group having at least one lens and a second lens group having at least one lens;

a first support member for supporting the first lens group; and

a second support member for supporting the second lens group,

wherein the first support member and the second support member are engaged with each other and provided slidably in an optical axis direction.

### BRIEF DESCRIPTION OF THE DRAWINGS

FIG. 1 is a structural view showing an optical pickup apparatus according to a first embodiment of the present invention;

FIG. 2 is a graph showing a lens-groups interval relationship in the case where a first lens group 11 is moved;

FIG. 3 is a graph showing a lens-groups distance relationship in the case where a second lens group 12 is moved;

FIG. 4 is a schematic perspective view showing a spherical aberration correcting mechanism in the present embodiment;

FIG. 5 is a cross-sectional view taken along the line 5-5 of FIG. 4;

FIGS. 6A and 6B are optical views showing conventional adjusting mechanisms;

FIG. 7 is a perspective view showing a conventional adjusting mechanism;

FIG. 8 is a structural view showing the conventional adjusting mechanism; and

FIG. 9 is a schematic perspective view showing the conventional adjusting mechanism.

### DETAILED DESCRIPTION OF THE PREFERRED EMBODIMENTS

Hereinafter, a best mode for embodying the present invention will be described in detail with reference to the drawings.

### First Embodiment

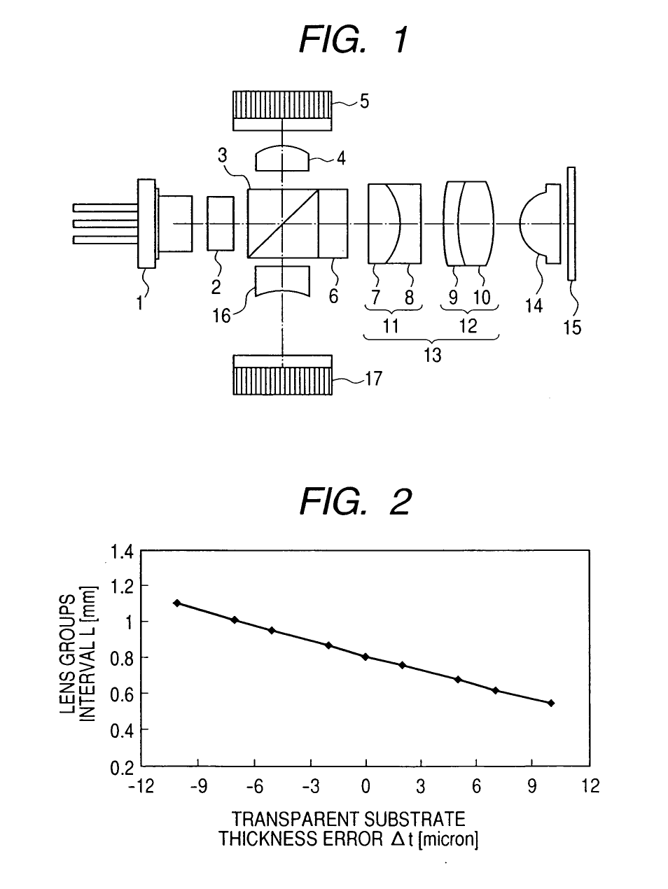

FIG. 1 is a structural view showing an optical pickup apparatus according to a first embodiment of the present invention.

In FIG. 1, reference numeral 1 denotes a semiconductor laser, 2 denotes a diffractive grating, 3 denotes a polarization beam splitter (PBS), 4 denotes a condensing lens, 5 denotes a monitor photo diode (PD), 6 denotes a λ/4-plate, 7 to 10 denote lenses, 11 denotes a first lens group, 12 denotes a second lens group, 13 denotes a collimator lens serving as a lens unit, 14 denotes an objective lens, 15 denotes an optical disk, 16 denotes a sensor lens, and 17 denotes a radio frequency (RF) and servo PD.

A light beam emitted from the semiconductor laser I is separated into a main beam and two sub-beams by the diffractive grating 2.

The sub-beams are used for generation of a servo signal for differential push-pull (DPP).

A part of the light beams from the diffractive grating 2 is reflected on the PBS 3 and condensed to the monitor PD 5 through the condensing lens 4.

An output of the monitor PD 5 is used for control of light emission power of the semiconductor laser 1.

The light beam passing through the PBS 3 passes through the λ/4-plate 6 and is converted to a parallel light beam by the collimator lens 13 serving as the lens unit. Then, the light beam is imaged by the objective lens 14 onto an information recording surface through a transparent substrate.

The optical disk 15 is composed of the transparent substrate and the information recording surface.

The light beam which is reflected on the optical disk 15 is condensed by the objective lens 14 and reflected on the PBS 3 through the collimator lens 13 and the λ/4-plate 6. The reflected light beam is condensed onto the RF and servo PD 17 by the sensor lens 16.

The collimator lens 13 includes two lens groups, that is, the first lens group 11 composed of the spherical lenses 7 and 8 and the second lens group 12 composed of the spherical lenses 9 and 10.

An information signal and a serve signal are generated based on an output of the RF and servo PD 17.

The case where the transparent substrate of the optical disk 15 has a thickness error will be described below.

When the transparent substrate has a thickness error, spherical aberration is caused, as is well known. When a short-wavelength light source and a high-NA objective lens are used, the influence of the thickness error is large.

Therefore, in this embodiment, an interval between the first lens group 11 composed of the spherical lenses 7 and 8 and the second lens group 12 composed of the spherical lenses 9 and 10 in the collimator lens 13 serving as the lens unit is changed to correct the caused spherical-aberration.

Next, a relationship between the thickness error of the transparent substrate and a lens groups interval for correcting the thickness error will be described.

Here, a wavelength of the semiconductor laser 1 is about 407 nm in information reproduction, the NA of the objective lens 14 is 0.85, and a focal distance thereof is 1.1765 mm.

Table 1 shows design values of a projection system in this embodiment. In Table 1, N (407) indicates a refractive index at a wavelength of 407 nm, ΔN indicates a change in refractive index when the wavelength is increased by 1 nm and corresponds to the dispersion of the refractive index at the vicinity of the wavelength of 407 nm. When a distance in the optical axis direction is X, a height from the optical axis in a direction perpendicular to the optical axis is h, and a conic coefficient is k, an aspherical shape is expressed by the following Equation and shown in Table 2.

$$X = \frac{{h}^{2} / r}{1 + \sqrt{1 - ( 1 + k ) {h}^{2} / {r}^{2}}} + {Bh}^{4} + {Ch}^{6} + {Dh}^{8} + {Eh}^{10} + {Fh}^{12} + {Gh}^{14}$$

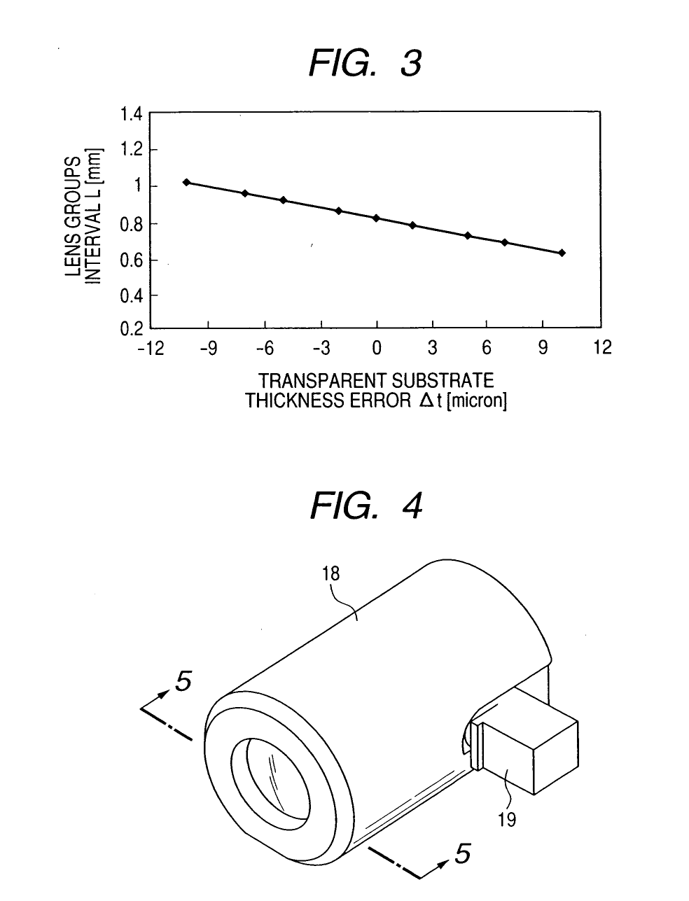

FIGS. 2 and 3 show a relationship of lens groups intervals obtained in the case where parameters shown in Tables 1 and 2.

TABLE 1

| | Remarks | r | d | N(407) | ΔN |
|---|---|---|---|---|---|
| 1 | LD | ∞ | 0.78 | | |
| 2 | | ∞ | 0.25 | 1.52947 | −0.00008 |
| 3 | | ∞ | 1.19 | | |
| 4 | Diffractive | ∞ | 1 | 1.52947 | −0.00008 |
| 5 | grating | ∞ | 1.6 | | |
| 6 | PBS | ∞ | 2.6 | 1.72840 | −0.00042 |
| 7 | λ/4-plate | ∞ | 1.15 | 1.56020 | −0.00020 |
| 8 | | ∞ | 1.46 | | |
| 9 | Collimator | ∞ | 1.29 | 1.58345 | −0.00014 |
| 10 | lens | −2.28 | 0.71 | 1.80480 | −0.00053 |
| 11 | | ∞ | 0.8 | | |
| 12 | | 13.49 | 0.74 | 1.80480 | −0.00053 |
| 13 | | 4.967 | 1.26 | 1.58345 | −0.00014 |
| 14 | | −4.411 | 6.5 | | |
| 15 | Objective | 0.89427 | 1.57 | 1.70930 | −0.00021 |
| (Aspherical | lens | | | | |
| surface 1) | | | | | |
| 16 | | −3.38795 | 0.27 | | |
| (Aspherical | | | | | |
| surface 2) | | | | | |
| 17 | Transparent | ∞ | 0.08 | 1.62068 | −0.00038 |
| 18 | substrate | ∞ | 0 | | |

TABLE 2

| Aspherical | Aspherical | Aspherical |
|---|---|---|
| coefficient | surface 1 | surface 2 |
| k | −4.71569E−01 | −8.03122E+02 |
| B | 1.85624E−02 | 6.93685E−01 |
| C | −3.32437E−03 | −7.23881E−01 |
| D | 2.00843E−02 | −1.08028E+01 |
| E | −2.46799E−02 | 5.02375E+01 |
| F | 3.71610E−02 | −6.88792E+01 |
| G | −2.00730E−02 | 0 |

FIG. 2 shows the case where the first lens group 11 was moved (the second lens group 12 was held). The amount of movement per 1 μm of the transparent substrate thickness error is about 28 μm.

FIG. 3 shows the case where the second lens group 12 was moved. In this case, the amount of movement per 1 μm of the transparent substrate thickness error is about 20 μm.

For example, when the entire collimator lens 13 is moved, the amount of movement per 1 μm of the transparent substrate thickness error is about 50 μm. When the first lens group 11 is to be moved, an entire length of the optical system does not change. Even when the second lens group 12 is moved, an amount required for the movement is about a half of the movement amount required in the case where the entire collimator lens 13 is moved, that is, it is sufficiently small. Therefore, the optical system can be made compact.

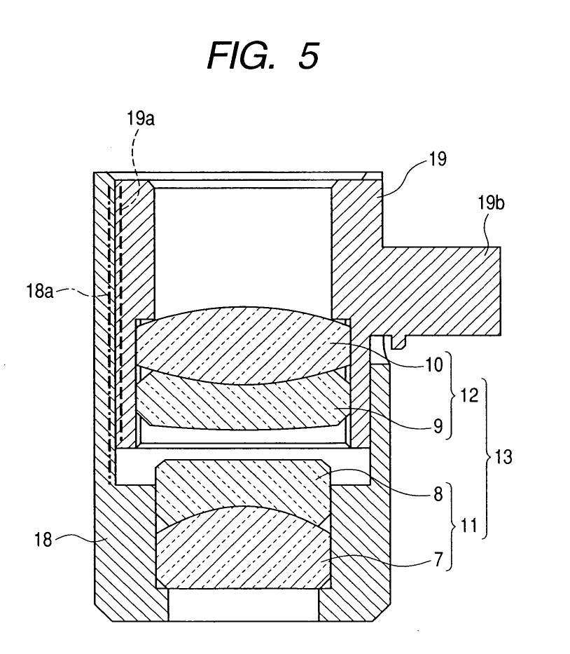

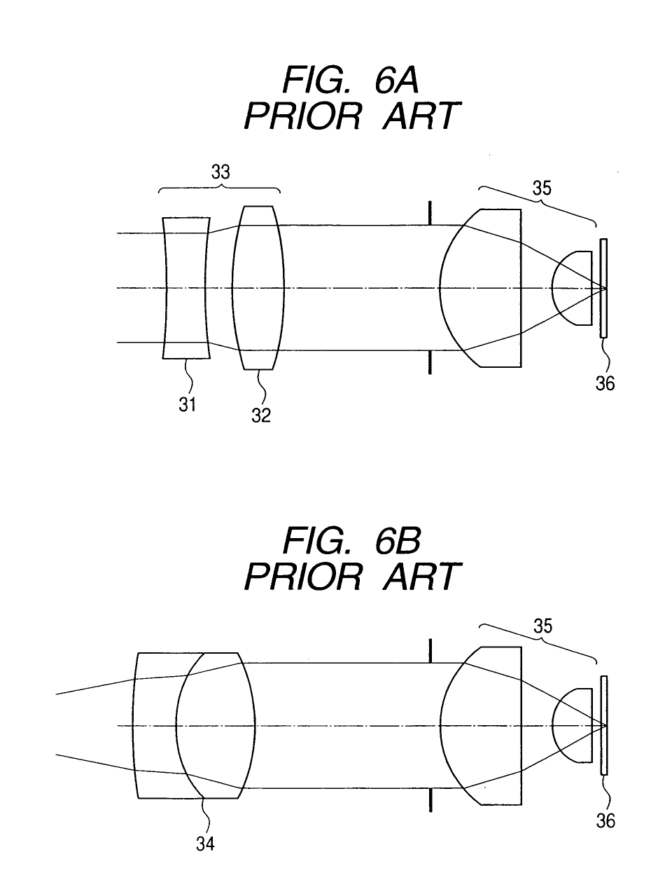

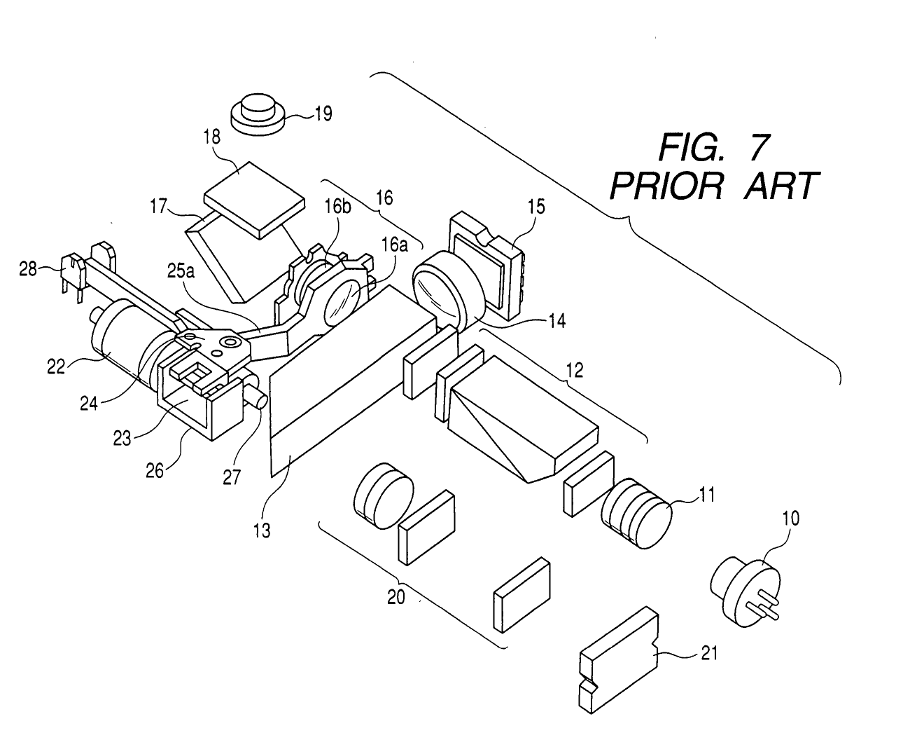

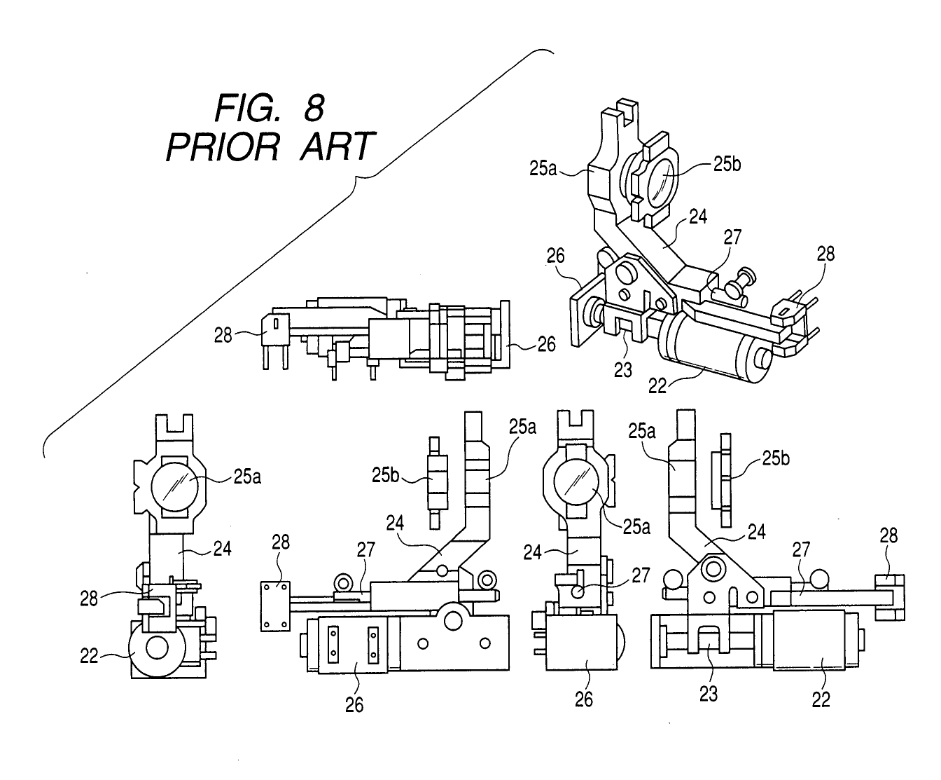

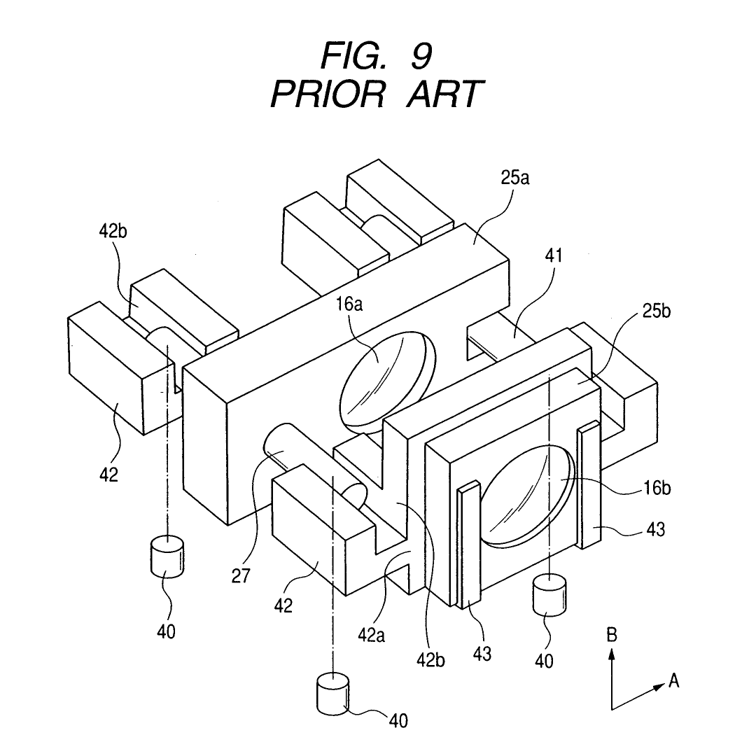

FIG. 4 is a schematic perspective view showing a spherical aberration correcting mechanism in this embodiment and FIG. 5 is a cross-sectional view taken along the line 5-5 of FIG. 4.

In FIGS. 4 and 5, reference numeral 18 denotes a first support member 18 for supporting the first lens group 11 and a second support member 19 for supporting the second lens group 12.

The first and second lens groups 11 and 12 are fixed to the first and second lens members 18 and 19, respectively, by press-fitting or the like while preferable coaxiality is obtained.

In this embodiment, the first lens group 11 is used as a held lens group and the second lens group 12 is used as a movable lens group.

In this embodiment, each of the support members is formed in a substantially cylindrical shape concentric to the lens members.

An external slide portion 19a (indicated by a broken line in FIG. 5) of the second support member 19 is engaged with an internal slide portion 18a (indicated by an alternate long and short dash line in FIG. 5) of the first support member 18 so as to slide the second support member 19.

A convex portion 19b is integrally provided on a part of the second support member 19. Although not shown in the drawings, for example, when a rack member, a stepping motor, and a lead screw are provided on the convex portion 19b in the same manner as in the expander mechanism described in Japanese Patent Application Laid-Open No. 2003-091847, the second support member 19 can be driven in the optical axis direction.

When the above-mentioned structure is used, it is possible to omit the guide shaft and the sub-shaft, unlike the conventional technique. Therefore, the number of parts can be reduced by two.

Factors in tolerance variations will be described below in detail.

Factors in coaxiality variations can be reduced to five factors such as

(c-1) coaxiality between the first lens group 11 and a lens engaging portion of the first support member 18,

(c-2) coaxiality between the lens engaging portion of the first support member 18 and the internal slide portion 18a thereof,

(c-3) coaxiality between the second lens group 12 and a lens engaging portion of the second support member 19,

(c-4) coaxiality between the lens engaging portion of the second support member 19 and the external slide portion 19a thereof, and

(c-5) engaging backlash of the internal slide portion 18a of the first support member 18 and the external slide portion 19a of the second support member 19.

In particular, with respect to the five factors in coaxiality variations, it can be assumed that (c-1)=(a-1), (c-3)=(a-8), and (c-5)=(a-3).

With respect to (c-2), the lens engaging portion of the first support member 18 and the internal slide portion 18a thereof are simultaneously processed by continuous turning so that the portions with the high coaxiality can be realized. With respect to (c-4), the same is expected.

In contrast to this, with respect to (a-2) and (a-5) in the conventional technique, even in the case of the same parts, they are not formed in a concentric shape, so it is necessary to change a processing location after the lens engaging portion is processed. Therefore, there is a variation in feed precision of a processing apparatus.

Thus, according to the structure of the present invention, it is possible to reduce the variation by which the coaxiality is affected, unlike the conventional technique.

Unlike the conventional technique, factors in tilt variations can be reduced to four factors such as

(d-1) a tilt of the first lens group 11 relative to the internal slide portion 18a of the first support member 18,

(d-2) a tilt of the second lens group 12 relative to the external slide portion 19a of the second support member 19,

(d-3) a tilt caused by engaging between the internal slide portion 18a of the first support member 18 and the external slide portion 19a of the second support member 19, and

(d-4) a tilt of the first support member 18 located on a holding side relative to the optical base.

In particular, with respect to the four factors in tilt variations, it can be assumed that (d-1) (b-1), (d-2)=(b-4), (d-3)=(b-2), and (d-4)=(b-3).

According to the structure of the present invention, the first support member 18 located on the holding side and the second support member 19 are engaged with each other to carry out direct sliding. Therefore, it is unnecessary to adjust the tilts of the first lens group 11 and the second lens group 12 and the coaxiality therebetween.

The present invention is not restricted to only the above-mentioned embodiment and thus can be applied to, for example, the expander mechanism as described above in the conventional technique.

This application claims priority from Japanese Patent Application No. 2004-309678 filed on Oct. 25, 2004, which is hereby incorporated be reference herein.

What is claimed is:

1. An optical pickup apparatus for condensing light emitted from a light source to a recording surface of an optical recording medium by an objective lens to perform one of information recording and information reproduction, comprising:
a lens unit for spherical aberration correction, comprising a first lens group including at least one lens and a second lens group including at least one lens;
a first support member for supporting the first lens group; and
a second support member for supporting the second lens group,
wherein the first support member and the second support member are engaged with each other and provided slidably in an optical axis direction.

2. An optical pickup apparatus according to claim 1, wherein the lens unit has a function of a collimator lens.
